(19) United States
(12) Patent Application Publication
(10) Pub. No.: US 2020/0332374 A1
(43) Pub. Date: Oct. 22, 2020

(54) METHOD FOR PRE-CLARIFICATION OF MOLASSES TO IMPROVE THE FERMENTATION EFFICIENCY THEREOF

(71) Applicant: Vasantdada Sugar Institute, Pune Maharashtra (IN)

(72) Inventors: Sanjay V. PATIL, Pune-Maharashtra (IN); D. R. TAKATE, Pune-Maharashtra (IN); Ashtavinayak D. PARADH, Yavatmal Maharashtra (IN); R. S. PATIL, Pune-Maharashtra (IN)

(73) Assignee: Vasantdada Sugar Institute, Pune Maharashtra (IN)

(21) Appl. No.: 16/850,281

(22) Filed: Apr. 16, 2020

(30) Foreign Application Priority Data
Apr. 17, 2019 (IN) 201821039366

(51) Int. Cl. C13B 20/12

(52) U.S. Cl. CPC C13B 20/126

(57) ABSTRACT

A method for pre-clarification of molasses to improve the fermentation efficiency of the molasses and reduce a proportion of the cations in the molasses. The method improves fermentation performance for ethanol production using Saccharomyces cerevisiae. The pre-clarified molasses in accordance with the present invention showed a 2.64% increase in fermentation efficiency.

### CROSS-REFERENCE TO RELATED PATENT APPLICATION(S)

This United States Non-Provisional Patent Application claims priority to and relies for priority on Indian Patent Application Number 201821039366, filed on Apr. 17, 2019, entitled “METHOD FOR PRE-CLARIFICATION OF MOLASSES TO IMPROVE THE FERMENTATION EFFICIENCY THEREOF,” the entire contents of which is incorporated herein by reference.

### FIELD OF THE INVENTION

The present invention generally relates to treatment of molasses and more particularly, to a method for pre-clarification of molasses for improving ethanol production.

### BACKGROUND OF THE INVENTION

India is the second largest producer of sugar and fourth largest producer of alcohol in the world. It is also the leading producer of alcohol in the South-East Asian region with about 65% of the share. The major raw material for distilleries is the molasses, a waste byproduct of sugar mills, and grains. Sugarcane, the raw material for sugar mills, is one of the leading crops of the country. Molasses, a byproduct of sugar industries is the major raw material for distilleries in India. There are about 356 molasses based distilleries and about 110 grain based distilleries in the country. It is estimated that the revenue contribution to government (both state and central) by sugar industry is about Rs. 6000-6500 crores per annum, while the figure for distillery (including bottling activities) is about Rs. 2.5-3.0 lakh crore/annum. It is apparently the second largest revenue contributor per annum for the government.

The economics of distillery is mostly defined by fermentation and distillation efficiencies. The distillation efficiency achieved by technologies available provide optimal efficiency of around 98.5%, hence there is limited scope for improvement in distillation efficiency. On the contrary, the fermentation efficiency of molasses based distilleries is ranging in between 87 to 90% depending on type of fermentation technology used. Hence, the improvement in fermentation efficiency can be a big booster for distillery and its associated profit margin.

For the first time Gustave et al, 1949 described clarification procedure for molasses using sulfuric acid and heating to remove calcium salts. During 1950s-70s various researchers have described various methods of pre-clarification of molasses. U.S. Pat. No. 250,261 (1950), U.S. Pat. No. 2,868,677 (1959), U.S. Pat. No. 2,916,404 (1959) and Olbrich (1963). Olbrich provided comprehensive component analysis of molasses and removal of inorganic such as K and Na using ion-exchange membranes. He also described role of viscosity in removal of these inorganic impurities from molasses. Olbrich also explained about centrifugal separation of impurities and inhibition of microbial flora of molasses. These methods have disadvantage of use of costly material or chemicals for treatment thus increasing the cost of production.

From 1970 till 2000 various recent methods such as ultra-filtration, micro and ultra-centrifugation, electro-dialysis, use of self-rejecting membranes, ion exchange membranes have been described by various researchers. For example, U.S. Pat. No. 4,379,845 (1986), U.S. Pat. No. 4,138,501 (1979), Bernhardt, H. W. (1998), Kishiihara et al. (1986), Verma et al. (1996), Kulkari and Godbole, (1992), Kundu et al., (1984) have described various methods for pre-clarification of molasses such as sulfuric acid treatment, potassium ferrocynide, tri-calcium phosphate, tri-calcium phosphate with hydrochloric acid and Sphadex fraction with combination of tri-calcium phosphate with hydrochloric acid. Most of these pre-clarification methods described are related to citric acid production from molasses (selective pre-clarification).

The recent study by Shazia Ashraf et al. (2015) deals with the pre-treatment of sugar cane molasses for the enhanced production of citric acid by Aspergillus niger NG-4. For this purpose, different acids such as H₂SO₄, HNO₃ and HCl were used.

Carbonation treatment has been described in the literature for reduction of ions especially phosphates from sugar cane juice (Saska et al., 2010, Hemerski et al., 2012). Further, carbonation method for clarification of sugar cane juice has been described in the literature (Hamerski et al., 2012).

From the prior art, it can be concluded that dilute acid treatment has been extensively studied for pre-clarification of molasses. These studies were performed either in isolation (only acid treatment) or for different end product (citric acid, sugar syrup, removal of sludge etc.) and not targeted enhanced ethanol production. Moreover, dilute acid treatment prevailed for treatment of molasses for ethanol production showed various disadvantages such as loss of sugars during process. However, carbonation method has not been documented for pre-clarification of molasses. There is scope for study of application of carbonation treatment of reducing the ionic content of Indian molasses before fermentation. One of the advantages of using carbonation method is that CO₂ is readily available with distilleries as it is generated during the fermentation.

Accordingly, there exists a need for a process of pre-treatment of molasses that improves fermentation efficiency by removing and/or reducing metal cations in molasses that inhibits fermentation process.

### SUMMARY OF THE INVENTION

One aspect of the present invention is to provide a process for pre-clarification of molasses to improve fermentation efficiency of molasses.

Another aspect of the present invention is to provide a process for reducing the proportion of metal cations in molasses that inhibits the fermentation process.

Accordingly, the present invention provides a method for pre-clarification of molasses to improve the fermentation efficiency thereof Δt a first step the method involves diluting molasses with water in the range of 35 to 40° Brix. The diluted molasses is charged to a reactor and the diluted molasses is heated until temperature reaches 80° C. Thereafter, the molasses is carbonated by purging CO₂ gas for a predefined period of time at a predefined rate. Specifically, the purging of CO₂ gas is carried out for 15-60 minutes with CO₂ gas flowing at the rate in the range of 0.5-6 vvm. More specifically, the purging of CO₂ gas is carried out for 30 minutes with CO₂ gas flowing at the rate of 2 vvm.

The polyelectrolyte is added to the carbonated molasses at dosage in the range of 2.5-10.0 ppm. More specifically, the polyelectrolyte is added to the carbonated molasses at dosage of 5 ppm. The polyelectrolyte treated molasses is cooled up to 32° C. and allowed to settle for 30 min-100 min. The cooled molasses is diluted in the range of 25-30° Brix by adding water. The diluted molasses is inoculated with 5-20% inoculums. The method of the present invention improves the fermentation efficiency of the molasses and reduces proportion of cations in the molasses.

### BRIEF DESCRIPTION OF THE DRAWING(S)

The objects and advantages of the present invention will become apparent when the disclosure is read in conjunction with the following figures, wherein

FIG. 1 shows a flow chart of a method for pre-clarification of molasses, in accordance with the present invention.

### DETAILED DESCRIPTION OF EMBODIMENT(S) OF THE INVENTION

The foregoing objects of the present invention are accomplished and the problems and shortcomings associated with the prior art, techniques and approaches are overcome by the present invention as described below in the preferred embodiments.

The present invention provides a method for pre-clarification of molasses to improve the fermentation efficiency thereof. The method of the present invention improves the fermentation efficiency of the molasses and reduces proportion of cations in the molasses. Specifically, the method improves fermentation performance for ethanol production using Saccharomyces cerevisiae. The pre-clarified molasses in accordance with the present invention showed 2.64% increase in fermentation efficiency.

The present invention is illustrated with reference to the accompanying drawings, wherein numbers indicated in the bracket represent the components of the invention throughout the description.

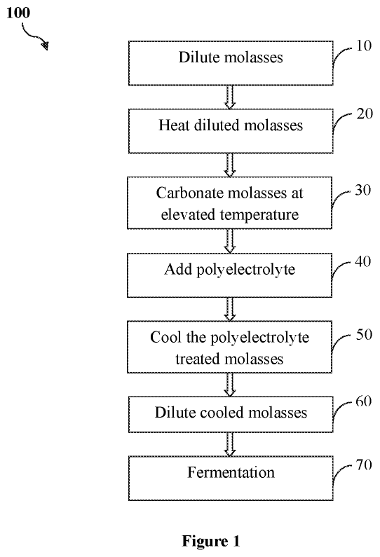

Referring to FIG. 1, a method (100) for pre-clarification of molasses to improve the fermentation efficiency thereof in accordance with the present invention is shown.

At step (10), the method (100) involves diluting the molasses with water in the range of 35 to 40° Brix. Specifically, the molasses is diluted to 40° Brix. Water is added slowly to the molasses and stirred for proper mixing. Brix hydrometer is used to measure the brix of molasses.

At step (20), the method (100) involves charging the diluted molasses of step (10) to a reactor and heating the diluted molasses until the temperature reaches 80° C. It is understood here that the reactor of any capacity may be used in accordance with the present invention.

At step (30), the method (100) involves carbonating the molasses by purging CO₂ gas for a predefined period of time at a predefined rate. Specifically, the purging of CO₂ gas is carried out for 15-60 minutes with CO₂ gas flowing at the rate in the range of 0.5-6 vvm. More specifically, the purging of CO₂ gas is carried out for 30 minutes with CO₂ gas flowing at the rate of 2 vvm.

At step (40), the method (100) involves adding polyelectrolyte to the carbonated molasses from step (30). In an embodiment, the polyelectrolyte is added at the dosage in the range of 2.5-10.0 ppm. Specifically, the polyelectrolyte is added at dosage of 5 ppm.

At step (50), the method (100) involves cooling the polyelectrolyte treated molasses from step (40) up to 32° C. and settling for 30-100 minutes. Specifically, the settling of polyelectrolyte treated molasses is done for 60 min.

At step (60), the method (100) involves diluting the cooled molasses to 25-30 Brix by adding water. Specifically, the cooled molasses is diluted up to 30 Brix by adding water.

At step (70), the method (100) involves inoculating the cooled molasses with 5-20% inoculum mixture to initiate the fermentation. Specifically, the cooled molasses is inoculated by adding 10% inoculum. The fermentation is carried out for 20-30 hrs. Specifically, the fermentation is carried out for 24 hr.

The invention is further illustrated hereinafter by means of examples.

### EXAMPLES

Molasses was pretreated using different existing methods and the method of the present invention. Resulting molasses from each method were tested for reduction in sodium, potassium and calcium ion content.

### Example 1: Pretreatment of Molasses Using Dilute Sulfuric Acid at Flask Level

Sugarcane molasses sample was diluted to Brix 40 in 500 ml volume and pH was maintained to 4.5 using 10% dilute sulphuric acid. Further, the diluted molasses was heated to 80° C. for the duration of 30 min. The treated molasses sample was further allowed to settle for 1 hour. The treated molasses sample 1 was analysed for percent reduction in Na, K and Ca using ion chromatography.

### Example 2: Pretreatment of Molasses Using Dilute Phosphoric Acid at Flask Level

Sugarcane molasses sample was diluted to Brix 40 in 500 ml volume and pH was maintained to 4.5 using 10% dilute phosphoric acid. Further, the diluted molasses was heated to 80° C. for the duration of 30 min. The treated molasses sample was further allowed to settle for 1 hour. The resulting molasses sample 2 was analyzed for percent reduction in Na, K and Ca using ion chromatography.

### Example 3: Pretreatment of Molasses Using Carbonation at Flask Level

Sugarcane molasses sample was diluted to Brix 40 in 500 ml volume and heated to 80° C. CO₂ purging was conducted at 3 L/min (6 vvm) flow rate for 30 min. The treated molasses sample was further allowed to settle for 1 hour. The resulting molasses sample 3 was analyzed for percent reduction in Na, K and Ca using ion chromatography.

### Example 4: Pretreatment of Molasses Using Carbonation Followed by Polyelectrolyte Treatment at Flask Level

Sugarcane molasses sample was diluted to Brix 40 in 500 ml volume and heated to 80° C. CO₂ purging was conducted at 3 L/min (6 vvm) flow rate for 30 min. Polyelectrolyte dosage of 5 ppm was added to the treated molasses. The treated molasses sample was further allowed to settle for 1 hour. The resulting molasses sample 4 was analyzed for percent reduction in Na, K and Ca using ion chromatography.

Table 1 shows percent reduction of Na, K and Ca, tested using ion chromatography.

TABLE 1

| Pretreated | Percent Sodium | Percent Potassium | Percent calcium |
|---|---|---|---|
| Molasses Sample | ion reduction | ion reduction | ion reduction |
| Sample 1 | 22.87 | 34.58 | 40.58 |
| Sample 2 | 7.82 | 18.35 | 20.03 |
| Sample 3 | 32.60 | 14.39 | 35.09 |
| Sample 4 | 20.00 | 27.66 | 55.54 |

### Example 5: Fermentation of Pretreated Molasses and Non-Treated Molasses

Molasses was pre-clarified in 20 L reactor by diluting it to 40° Brix, temperature of 80° C., CO₂ purging with flow rate of 30 L/min (2 vvm) for 30 min, polyelectrolyte at 5 ppm dose and settling time of 60 min. The final volume of pre-clarified molasses was 15 L. After pre-clarification of molasses, samples were further diluted to 30° Brix and 500 ml of inoculum prepared as given above was added. Fermentation experiments for molasses pre-clarified with the present method (100) and non-clarified molasses were carried out at 10 L scale. For 10 L scale, two NBS fermenters were used for experiments, first for control (non-clarified molasses) and second for pre-clarified molasses. Fermentation was allowed to proceed at 32-33° C. with agitation for about 28 hrs for pre-clarified and non-clarified molasses. Final ethanol concentration of fermenting broth was obtained as 10.23% (v/v) for pre-clarified molasses that of 9.93% (v/v) for control (non-clarified molasses).

Table 2 below shows the summary of the fermentation performance of non-clarified and pre-clarified molasses.

TABLE 2

| | | Non-clarified | Pre-clarified |
|---|---|---|---|
| Time | Parameter | molasses | molasses |
| 0 h | Strain | VSI 1011 | VSI 1011 |
| | Inoculum size (%) | 20.0 | 20.0 |
| | pH | 5.35 | 5.20 |
| | Cells/ml | 8.9 × 10⁷ | 8.9 × 10⁷ |
| | Initial sugar (%) | 17.76 | 17.40 |
| 28 h | Cells/ml | 1.98 × 10⁸ | 2.08 × 10⁸ |
| | Final sugar (%) | 2.029 | 1.949 |
| | Ethanol (%) (v/v) | 9.93 | 10.23 |
| | Fermentation | 89.02 | 91.66 |
| | Efficiency (%) | | |
| | Ethanol yield based on | 266.63 | 274.54 |
| | FE (L/MT) | | |

Results of Table 2 show nearly 2.64% increase in the fermentation efficiency of pre-clarified molasses as compared with that of the non-clarified molasses. Ethanol yield was calculated based on fermentable sugar present considering actual fermentation efficiency. Yield for control experiment was found to be 266.63 L/MT while for pre-clarified molasses showed yield of 274.54 L/MT respectively.

### Advantage(s) of the Invention

1. The method for pre-clarification of molasses improves the fermentation efficiency of the molasses.

2. Proportion of cations in the molasses is reduced when the molasses is pre-clarified using the method.

3. The method allows use of CO₂ which is generated in the distillery during fermentation for pre-clarification purpose.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

What is claimed is:

1. A method for pre-clarification of molasses to improve the fermentation efficiency thereof, the method comprising the steps of:
diluting the molasses with water in the range of 35 to 40° Brix;
charging the diluted molasses to a reactor and heating the diluted molasses until temperature reaches 80° C.;
carbonating the molasses by purging CO₂ gas for a predefined period of time at a predefined rate;
adding polyelectrolyte to the carbonated molasses;
cooling the polyelectrolyte treated molasses up to 32° C. and settling for 30-100 min;
diluting the cooled molasses by adding water in the range of 25-30° Brix; and
inoculating the cooled molasses with 5-20% inoculum mixture for fermentation.

2. The method as claimed in claim 1, wherein the purging of CO₂ gas is carried out for 15 to 60 minutes with CO₂ gas flowing at the rate in the range of 0.5-6 vvm.

3. The method as claimed in claim 2, wherein the purging of CO₂ gas is carried out for 30 minutes with CO₂ gas flowing at the rate of 2 vvm.

4. The method as claimed in claim 1, wherein the polyelectrolyte is added to the carbonated molasses at dosage in the range of 2.5-10.0 ppm.

5. The method as claimed in claim 4, wherein the polyelectrolyte is added to the carbonated molasses at dosage of 5 ppm.
